(19) United States
(12) Patent Application Publication
(10) Pub. No.: US 2025/0008895 A1
(43) Pub. Date: Jan. 9, 2025

(54) SYSTEMS AND METHODS FOR PROVIDING A MODULAR GROW TOWER

(71) Applicant: Tavaci Technologies LLC, Alpine, UT (US)

(72) Inventors: Sean R. Peterson, Payson, UT (US); Johndavid Tueller, Orem, UT (US); Todd Garrett Tueller, Alpine, UT (US); Ryan Joseph Crawford, Salem, UT (US)

(21) Appl. No.: 18/765,039

(22) Filed: Jul. 5, 2024

Related U.S. Application Data
(60) Provisional application No. 63/512,129, filed on Jul. 6, 2023.

(51) Int. Cl. A01G 31/04; A01G 31/00; A01G 31/06

(52) U.S. Cl. CPC A01G 31/04; A01G 31/06; A01G 2031/006

(57) ABSTRACT

The present disclosure presents modular grow tower systems and related methods. One such system comprises a modular grow tower assembly having a plurality of body frames, a plurality of lift frames, and a plurality of rows extending in a longitudinal direction and stacked in a vertical direction; a plurality of carts for supporting crop material, one or more lowering lift mechanisms for vertically translating the carts between rows; one or more raising lift mechanisms for vertically translating the carts; a sustenance system for providing water and nutrients to the crop material; a lighting system including lighting elements mounted within the body frames; a drainage system comprising drainage troughs and drainage pipes for collecting and transporting excess water and nutrients; and/or a master controller for managing and controlling operations of the modular grow tower system.

### CROSS-REFERENCE TO RELATED APPLICATION

This application claims priority to co-pending U.S. provisional application entitled, “Systems and Methods for Providing a Modular Grow Pod,” having application No. 63/512,129, filed Jul. 6, 2023, which is entirely incorporated herein by reference.

### TECHNICAL FIELD

Embodiments described herein generally relate to systems and methods for providing a modular grow tower and, more specifically, to embodiments for providing a grow tower that includes a plurality of modular parts.

### BACKGROUND

While crop growth technologies have advanced over the years, there are still many problems in the farming and crop industry today. As an example, while technological advances have increased efficiency and production of various crops, many factors may affect a harvest, such as weather, disease, infestation, and the like. Additionally, while the United States currently has suitable farmland to adequately provide food for the U.S. population, pets, and livestock, other countries and future populations may not have enough farmland to provide the appropriate amount of crop material for these purposes.

### SUMMARY

Embodiments of the present disclosure present modular grow tower systems and related methods. One such system comprises a modular grow tower assembly having a plurality of body frames; a plurality of lift frames; and a plurality of rows extending in a longitudinal direction and stacked in a vertical direction. An exemplary system further includes a plurality of carts for supporting crop material, each cart including a plurality of wheels; and a tray for holding crop material. Such systems may also include one or more lowering lift mechanisms for vertically translating the carts between rows; one or more raising lift mechanisms for vertically translating the carts; a sustenance system for providing water and nutrients to the crop material; a lighting system including lighting elements mounted within the body frames; a drainage system comprising drainage troughs and drainage pipes for collecting and transporting excess water and nutrients; and/or a master controller for managing and controlling operations of the modular grow tower system.

In one or more aspects for modular grow tower systems and related methods, an individual one of the one or more raising lift mechanisms are located within a harvest frame; the one or more lowering lift mechanisms are positioned within the lift frames; the modular grow tower assembly is configurable to adjust a size and arrangement of the modular grow tower assembly by adding or removing body frames or lift frames; the carts traverse a moving path through the modular grow tower assembly, facilitated by the lowering lift mechanisms and the raising lift mechanisms; the moving path comprises a serpentine moving path; the master controller is configured to manage environmental factors including: lighting, temperature, humidity, airflow, and nutrient delivery through the sustenance system; the master controller is configured to adjust the environmental factors and grow recipes based on user input; the lowering lift mechanisms and the raising lift mechanisms are synchronized to facilitate a transition of carts between different rows and sections of the modular grow tower assembly; the carts include sensors for monitoring crop growth and development, wherein the master controller adjusts one or more grow recipes based on data from the sensors; the sustenance system is configured to deliver precise amounts of water and nutrients to the crop material and includes spray nozzles, drip nozzles, flood nozzles, and/or fluid lines; the drainage system is configured to reuse collected water and nutrients within the sustenance system; and/or each cart includes male and female engagement mechanisms for connecting adjacent carts to maintain alignment and ensure smooth movement through the modular grow tower assembly.

In one or more aspects, the modular grow tower system can further comprise a seeding component mounted on one of the lift frames for dispensing crop material into the carts; a harvesting component for harvesting crop material from the carts; and/or a sanitation component for cleaning the carts after harvesting. In one or more aspects, the sanitation component includes one or more ultraviolet sensors, imaging sensors, or microbial sensors.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a perspective view of a modular grow tower according to one or more embodiments shown and described herein;

FIG. 2 depicts a partially exploded view of a modular grow tower assembly of FIG. 1 according to one or more embodiments shown and described herein;

FIG. 3 depicts a body frame of the modular grow tower assembly of FIG. 2 according to one or more embodiments shown and described herein;

FIG. 4 depicts a lift frame of the modular grow tower assembly of FIG. 2 according to one or more embodiments shown and described herein;

FIG. 5 depicts a perspective view of a cart for receiving crops in the modular grow tower of FIG. 1 according to one or more embodiments shown and described herein;

FIG. 6 depicts a lowering lift mechanism of the modular grow tower assembly of FIG. 1 according to one or more embodiments shown and described herein;

FIG. 7A depicts a first embodiment of a sustenance system for providing water and/or nutrients to crops in the modular grow tower system of FIG. 1 according to one or more embodiments described herein;

FIG. 7B depicts a second embodiment of a sustenance system for providing water and/or nutrients to crops in the modular grow tower system of FIG. 1 according to one or more embodiments described herein;

FIG. 8 depicts a perspective view of a drainage component of the modular grow tower of FIG. 1 according to one or more embodiments shown and described herein;

FIG. 9 depicts a harvesting frame of the modular grow tower system of FIG. 1 according to one or more embodiments described herein;

FIG. 10 depicts a raising lift mechanism of the modular grow tower assembly of FIG. 1 according to one or more embodiments described herein;

FIG. 11 depicts a perspective view of a harvesting component of the modular grow tower system of FIG. 1 according to one or more embodiments shown and described herein;

FIG. 12 depicts a perspective view of a sanitizing component of the modular grow tower system of FIG. 1 according to one or more embodiments shown and described herein;

FIG. 13 depicts a perspective view of a seeding component of the modular grow tower system of FIG. 1 according to one or more embodiments shown and described herein;

FIG. 14 depicts a perspective view of a transfer apparatus of the seeding component of FIG. 13 according to one or more embodiments shown and described herein;

FIG. 15 depicts a computing environment for providing a modular grow tower system according to one or more embodiments described herein; and

FIG. 16 depicts a modular tower computing device according to one or more embodiments described herein.

### DETAILED DESCRIPTION

Embodiments disclosed herein include systems and methods for providing a modular grow tower. Some embodiments are configured with a modular grow tower assembly of carts containing crops. Crops may include traditional agricultural materials, for example, seeds, seedlings, plants, grasses, fully-grown crops, leafy crops, crop output, such as seeds, nuts, fruit, and/or the like. Crops may also include non-traditional materials, for example, microgreens, eggs, algae, insects, insect larvae, fungi, other kinds of organic material, and/or the like. The carts containing crops traverse the modular grow tower assembly via a moving path (e.g., serpentine moving path, circular moving path, curved or straight moving path, etc.). Various embodiments include a system for pushing and/or pulling a plurality of carts along the track using pushing/pulling mechanisms that are placed periodically across the width of the track. Furthermore, in various embodiments, a lift system including a plurality of lifts may be provided for raising or lowering the plurality of carts throughout the modular grow tower assembly of the modular grow tower system.

Some embodiments provided herein include systems and methods for maintaining the crops in the plurality of carts as the carts traverse the serpentine moving path of the modular grow tower assembly. Various embodiments may include mechanisms for receiving a cart from a growing row; harvesting crops from the cart, sanitizing the cart, seeding the cart, and/or putting the seeded cart back in circulation in the modular grow tower. Exemplary systems and methods for providing a modular grow tower incorporating the same will be described in more detail below. Whenever possible, the same reference numerals will be used throughout the drawings to refer to the same or like parts.

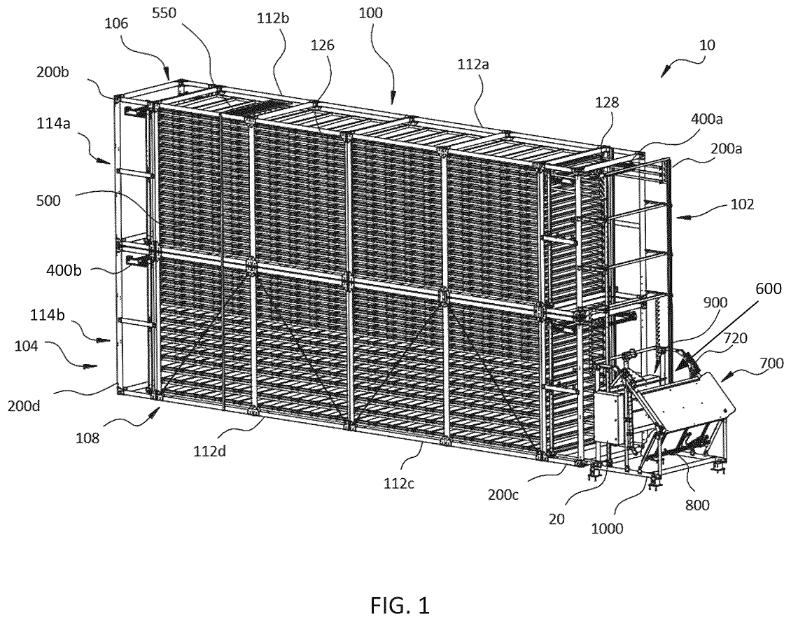

Referring now to FIG. 1, a modular grow tower system 10 (“modular grow tower”) is illustrated according to one or more embodiments described herein. The modular grow tower 10 may generally comprise a modular grow tower assembly 100 which may generally include a first end 102, a second end 104 opposite the first end 102, a top end 106, and a bottom end 108 opposite the top end 106. As discussed herein, the size of the modular grow tower assembly 100 is customizable based on user requirements and the type of crops grown within the modular grow tower assembly 100. The modular grow tower assembly 100 comprises a plurality of lift frames 200a . . . 200d (collectively referred to as 200) at the first end 102 and the second end 104, and a plurality of body frames 112a . . . 112d (collectively referred to as 112) that are positioned between the plurality of lift frames 200 at the first end 102 and the second end 104.

In various embodiments, the modular grow tower assembly and constituent lift frames and body frames can comprises a variety of materials, such as, but not limited to, aluminum alloys, titanium alloys, carbon fiber reinforced polymer (CFRP), glass fiber reinforced polymer (GFRP), high-strength low-alloy (HSLA) steel, stainless steel, bamboo, composite materials (hybrid), engineered wood products (e.g., cross-laminated timber (CLT)), high-strength thermoplastics (e.g., polycarbonate, polyether ether ketone (PEEK)).

The plurality of lift frames 200 and the plurality of body frames 112 are arranged in a plurality of rows 114a, 114b (collectively referred to as 114). Accordingly, each row 114 includes a lift frame 200 at a first end 102 and at a second end 104, and a plurality of body frames 112 provided between each of the lift frames 200. However, it should be appreciated that in some embodiments a single body frame 112 may be provided in each row 114. The rows 114 extend in a longitudinal direction and are stacked on top of one another in a vertical direction. As referred to herein, the rows 114 include a top row 114a and the bottom row 114b. Thus, this example of the present modular grow tower assembly 100 comprises four body frames 112a, 112b, 112c, 112d and four lift frames 200a, 200b, 200c, 200d. However, it should be appreciated that other configurations of the modular grow tower assembly 100 are contemplated as being within the scope of the present application.

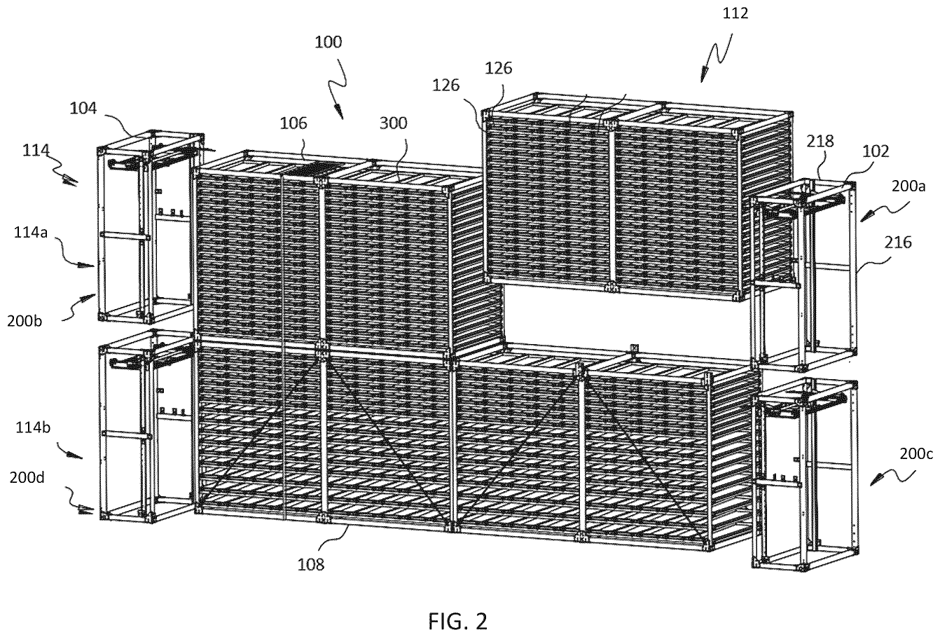

Referring now to FIGS. 1 and 2, the body frames 112 and the lift frames 200 may be attached to adjacent lift frames 200 and/or body frames 112. Accordingly, the lift frames 200 and the body frames 112 may be connected by utilizing any suitable fastening mechanism. Similarly, the lift frames 200 and the body frames 112 may be disconnected from one another to be rearranged as necessary to adjust the size of the modular grow tower assembly 100, i.e., the number of rows 114 and the number of body frames 112 within each row 114. In some embodiments each body frame 112 includes a plurality of rows of subframe supports 126. As illustrated in FIG. 2, each of the plurality of rows of subframe supports 126 may be populated with carts 300.

The modular grow tower system 10 may further comprise a plurality of lowering lift mechanisms 400a, 400b (collectively referred to as 400) confined within the lift frames 200 located at the first end 102 and the second end 104 of the modular grow tower assembly 100. In some embodiments, each of the lift frames 200a, 200b, 200c, 200d may include one lowering lift mechanism 400. As described in more detail herein, the carts 300 enter each lift frame 200 and are lowered in a vertical direction by the lowering lift mechanisms 400 such that the carts 300 are moved to a lower position within each row 114.

As depicted in FIG. 1, the modular grow tower system 10 may further comprise a raising lift mechanism 600, which may be located in harvest frame 1000. In some embodiments, the harvest frame 1000 may be located proximal to the lift frame 200c on the side of the modular grow tower assembly 100 where the moving path terminates. In some embodiments, the harvest frame 1000 may house the raising lift mechanism 600, a harvesting component 700 and a sanitation component 800.

In various embodiments, the lift mechanisms 600 may be powered via pneumatic arms and/or motors, such as a plurality of translating mechanisms positioned along a length of a track, where each translating mechanism has a plurality of motorized apparatuses (e.g., motors) configured to push or pull the carts in a longitudinal direction. Correspondingly, the motorized apparatuses may be configured to push and retrieve the carts using extendable and retractable mechanical mechanisms to move the carts a predetermined length. In various embodiments, such motorized apparatus may be comprise one or more of motors, belts, chains, rollers, tracks, conveyers, rack and pinion gears, hydraulic systems, pneumatic systems, linear actuators, screw jacks, winches, cables and pulleys, gear systems, cam mechanisms, scissor lifts, and/or magnetic levitation systems.

In various embodiments, the moving path may take various shapes. For example, the moving path may comprise a serpentine path, such as one that starts from the top, moving trays horizontally in one direction, then down one sequential row as they reach the end of the horizontal path. The trays then move in the opposite horizontal direction along the new row, then down another row to continue the same pattern, and so forth. Alternatively, in various embodiments, the moving path may comprise a C-Shape path, such that carts may move horizontally in one direction on the top half of the total rows, then down to the bottom half of the total rows where the lighting system may be located. The carts may then move horizontally in the opposite direction, being harvested at the bottom. Correspondingly, in some embodiments, the moving path may comprise alternating rows/skipping rows path such that carts may move from row A to row C and then, subsequently, carts may move from row B to row D, instead of A to B to C to D in sequence. Further, in various embodiments, the moving path may having batching collections of rows such that groups of rows may be set and left without movement for many days and then all moved to a new set of rows with different heights or systems in one rapid succession. For example, rows A, B, C, and D may be batched to be moved on the same day to rows I, J, K, and L, while rows E, F, G, and H remain stationary until the following day. Additionally, in various embodiments, the moving path may comprise a haphazard path such that carts from the top rows can be moved down to any of the lower rows where different systems such as nutrients, lighting, watering, and measuring are located, and then moved back up again to the same row of origin or another row, offering full versatility.

Once the carts 300 have traversed the moving path, such as serpentine moving path, from the top end 106 of the modular grow tower assembly 100 to the bottom end 108 of the modular grow tower assembly 100, the carts 300 may be transferred to the raising lift mechanism 600. After the cart 300 is received by the raising lift mechanism 600, the raising lift mechanism 600 may raise the cart 300 to engage a harvesting component 700, which may harvest crops located in the cart 300, and a sanitation component 800, which may sanitize the cart 300. Once the crops have been harvested and the cart 300 has been sanitized, the raising lift mechanism 600 may raise the cart 300 to a seeding component 900, which supplies new crops to the cart 300. After the tray receives crop material, the raising lift mechanism 600 may transfer the cart 300 to the lowering lift mechanism 400a which is located in the lift frame 200a connected to the seeding component 900. The lowering lift mechanism 400a may elevate the cart 300 through the lift frame 200a, such that the cart 300 is able to re-enter the modular grow tower assembly 100 at the top end 106 and traverse the serpentine moving path through the modular grow tower assembly 100 once again.

Also depicted in FIG. 1 is a master controller 20. The master controller 20 may include a computing device and/or other components for controlling the modular grow tower 10. The modular grow tower 10 may also include one or more environmental affecters, such as a lighting component, a pressure component, a heating component, a cooling component, a humidity component, an airflow component, a sustenance system 500 and/or other hardware for altering the environment and/or controlling various acid of the modular grow tower 10.

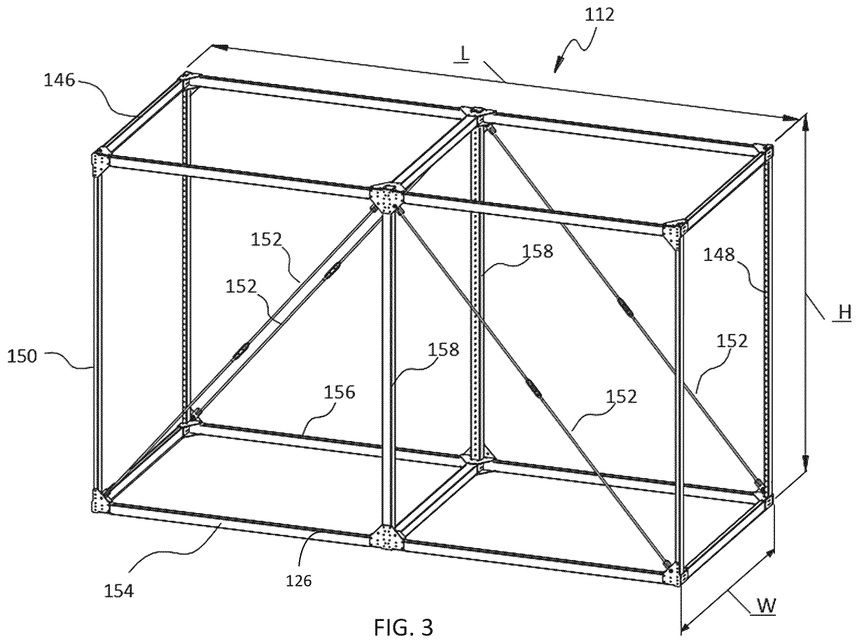

Referring now to FIG. 3, the body frame 112 is illustrated. Each body frame 112 is substantially similar in structure. Specifically, each body frame 112 includes an enclosure 146 defining a first end 148, and a second end 150 opposite the first end 148. In embodiments, each body frame 112 includes a pair of diagonal braces 152 extending along a first side 154 of the body frame 112 between the first end 148 and the second end 150, and a pair of diagonal braces 152 extending along an opposite second side 156 of the body frame 112 between the first end 148 and the second end 150.

In some embodiments, each body frame 112 includes a plurality of holes 158 for attaching the rows of subframe supports 126. Each subframe support 126 may be removably attached to the body frame 112 using any suitable fastener such as bolts, clips, and the like. The plurality of holes 158 permit the distance between adjacent subframe supports 126 of each body frame 112 to be adjusted. It should be appreciated that the distance between subframe supports 126 in each body frame 112 of the same row 114 is the same such that carts 300 are permitted to seamlessly move between body frames 112 of the same row 114. However, the distance between subframe supports 126 in one row 114 of body frames 112 may differ from the distance between subframe supports 126 in a different row 114 of body frames 112. This is due to the fact that as the carts 300 are translated to different rows 114 of body frames 112 by the lift frames 200 discussed herein, the height of the crops increases and requires more space to grow.

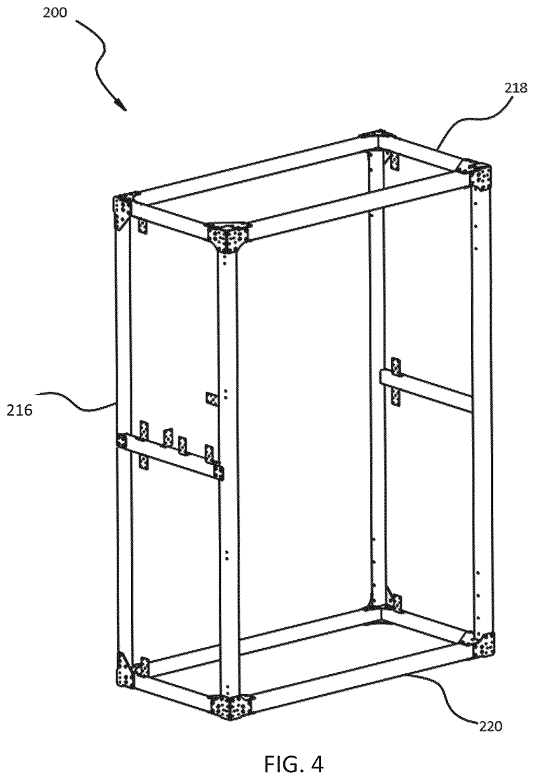

Turning now to FIG. 4, each lift frame 200 may be similar in structure. Specifically, each lift frame 200 may include an enclosure 216 defining a top end 218, a bottom end 220 opposite the top end 218, and utilizes a lowering lift mechanism 400 (FIG. 1) that translates between the top end 218 and the bottom end 220. As discussed in more detail herein, the lowering lift mechanism 400 operates to move carts 300 in a vertical direction to a different row 114 within each body frame 112. The lowering lift mechanism 400 may include any suitable device for moving the carts 300 in the vertical direction such as rollers, tracks, rack and pinion gears, and the like. As described in more detail herein, the carts 300 enter each lift frame 200 and are lowered in the vertical direction by the lowering lift mechanism 400 such that the carts 300 are moved to a lower subframe support 126 within each row 114. It should be appreciated that the carts 300 are each provided with crops.

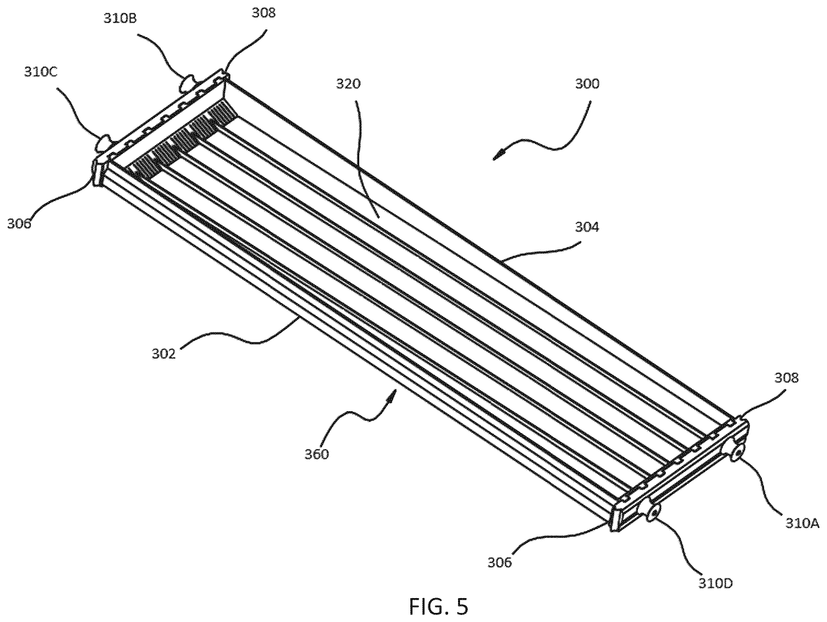

The structure of the cart 300 is most clearly illustrated in FIG. 5. The cart 300 may support a quantity of plant materials and/or microgreens and include a plurality of wheels 310A, 310B, 310C, and 310D (collectively referred to as 310) for supporting the crops as the carts 300 traverse the serpentine moving path of the modular grow tower assembly 100. The cart 300 may additionally include a tray 320, such as a foam reinforced thermoformed tray, that holds the crop material.

Referring still to FIG. 5, the cart 300 may include a first end 302 and a second end 304. In some embodiments, the first end 302 and second end 304 may each include an engagement mechanism which is configured to allow the cart 300 to engage with other carts 300. For example, the first end 302 of the cart 300 may include at least one male engagement mechanism 306 and the second end of the cart 300 may include at least one female engagement mechanism 308. The male engagement mechanism 306 may be configured to engage the female engagement mechanism 308 of an adjacent cart 300, such that each of the plurality of carts 300 may remain in contact as the carts 300 traverse the moving path of the modular grow tower assembly 100.

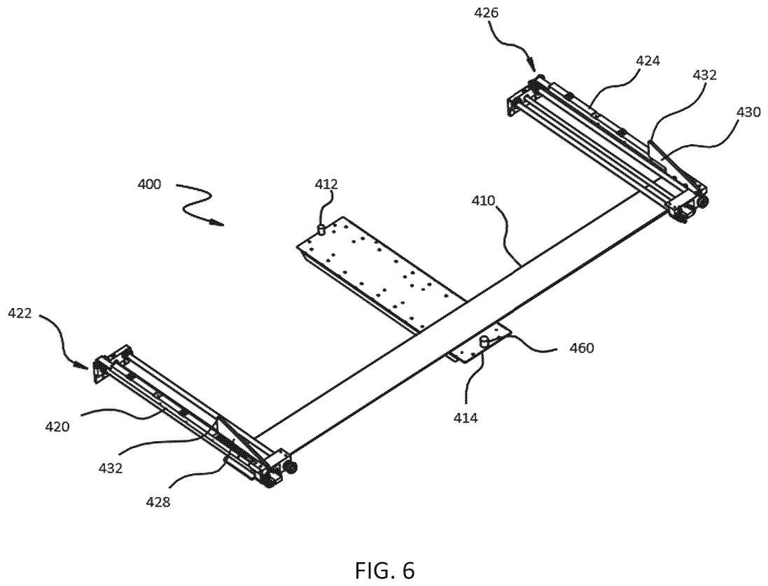

FIG. 6 illustrates the lowering lift mechanism 400, which may include a receiving plate 410 for engaging with the carts 300. The receiving plate 410 may further include a first arm 420 located on a first end 422 of the receiving plate 410, and a second arm 424 located on a second end 426 of the receiving plate 410 opposite the first end 422. Additionally, the first arm 420 may include a first receiving block 428, and the second arm may include second receiving block 430. The first and second receiving blocks 428, 430 may include a notch 432 which may be configured to engage the male engagement mechanism 306 and female engagement mechanism 308 of the carts 300.

The receiving plate 410 may be configured such that the receiving plate 410 may be actuated in a longitudinal direction between an extended position 412 and a retracted position 414. In the retracted position 414, the entirety of the receiving plate 410 may remain within its respective lift frame 200. In the extended position 412, the first and second arms 420, 424 may extend outside the lift frame 200 and into the subframe supports 126 of one of the body frames 112. In the extended position 412, the first and second arms 420, 424 may be configured to slide beneath the wheels 310 of the carts 300, and the notches 432 of the first and second receiving blocks, 428, 430 may be configured to engage the male and female engagement mechanisms 306, 308, of the carts 300.

It should be noted that, as an additional safety measure, each of the subframe supports 126 may include support stops 128 (FIG. 1). The support stops 128 may be located at the end of each subframe support 126 on a side which is adjacent to a lift frame 200. The support stops 128 may include a distal end which is adjacent to the lift frame 200, and a proximal end located opposite the distal end. The distal end may include a bumper, which may be configured to stop the motion of the carts 300 by stopping the wheels 310 of the cart. In some embodiments, the proximal end may have a downward slope, such that carts 300 which reach the proximal end of the support stop 128 will continue to roll across the support stop 128 until the wheels 310 of the cart 300 hit the bumper.

Due to the support stops 128, when the receiving plate 410 has engaged the cart 300, the lowering lift mechanism 400 must lift the cart 300 above the bumper prior to returning to the retracted position 414. As the lowering lift mechanism 400 raises the cart 300, the cart 300 may disengage from its adjacent cart 300 such that it may be pulled from the subframe support 126 on which it is located.

Once the cart 300 has been raised above the bumper, the cart 300 may be pulled from the subframe support 126 on which it is located and into the lift frame 200 by returning the receiving plate 410 to the retracted position 414. It should be noted that the receiving plate 410 may be actuated by any mechanism capable of actuating the receiving plate 410 between the extended position 412 and the retracted position 414, such as a motor, driver, actuator, or the like.

Once receiving plate 410 is returned to the retracted position 414 and the cart 300 is pulled completely into the lift frame 200, the lowering lift mechanism 400 may be configured to lower the cart 300 in a vertical direction such that the cart 300 is aligned with the subframe support 126 which is directly beneath the subframe support 126 from which the cart 300 was obtained. When the lowering lift mechanism has been lowered to align with the lower subframe support 126, the receiving plate 410 may be actuated to the extended position 412, thereby pushing the cart 300 out of the lift frame 200 and back onto the subframe support 126 of the body frame 112.

As the cart 300 is pushed onto the subframe support 126, the male and/or female engagement mechanism 306, 308 will engage with the male and/or female engagement mechanism 306, 308 of the adjacent cart 300 on the subframe support 126. As the cart 300 engages its adjacent cart 300, each of the carts 300 located on the subframe support 126 may be pushed towards the opposite lift frame 200.

In some embodiments, each of the plurality of lowering lift mechanisms 400 is configured such that the movements of the lowering lift mechanisms 400 are substantially synchronized. In this configuration, the lowering lift mechanism 400 may pull a cart 300 from a given subframe support 126 of the body frame 112 before the lowering lift mechanism 400 located in the opposite lift frame 200 pushes a cart 300 onto said subframe support 126. By synchronizing the plurality of lowering lift mechanisms 400 such that a cart 300 is pulled from the subframe support 126 prior to a new cart 300 being pushed onto the subframe support 126, it is possible to ensure that none of the plurality of carts 300 are pushed into the lift frames 200 when no lowering lift mechanism 400 is present.

Referring again to FIG. 1, the manner in which the carts 300 traverse the moving path of the modular grow tower assembly 100 includes the lowering lift mechanism 400a associated with the lift frame 200a receiving a cart 300 that has received new crops. The lowering lift mechanism 400a may be configured to raise the cart 300 to the top end 106 of the modular grow tower assembly 100, such that the lowering lift mechanism 400a is aligned with the uppermost subframe support 126 located at a first end 148 of body frame 112a.

Once the lowering lift mechanism 400a is in substantial alignment, the lowering lift mechanism 400b located in the opposite lift frame 200b may pull a cart 300 from uppermost subframe support 126 at the second end 150 of the body frame 112b. Once the cart 300 is secured in the lift frame 200b, the lowering lift mechanism 400a may push its cart 300 onto the uppermost subframe support 126 located at the first end 148 of the body frame 112a. As the lowering lift mechanism 400a pushes its cart 300 onto the subframe support 126, the male engagement mechanism 306 of the cart 300 may engage the female engagement mechanism of the adjacent cart 300 located on the uppermost subframe support 126 of the body frame 112a, such that each of the carts 300 located on the subframe support are pushed towards the opposite lift frame 200b.

After the lowering lift mechanism 400a has pushed its cart 300 onto the uppermost subframe support 126 of the body frame 112a, the lowering lift mechanism 400a may be lowered in a vertical direction through the lift frame 200a such that the lowering lift mechanism 400a aligns with the subframe support 126 located below the uppermost subframe support 126 of the body frame 112a. Once the lowering lift mechanism 400a is aligned, the lowering lift mechanism 400a may pull a cart 300 from the first end 148 of the body frame 112a and into the lift frame 200a. Once the cart 300 is secured on the lowering lift mechanism 400a inside the lift frame 200a, the lowering lift mechanism 400b may be lowered in a vertical direction through lift frame 200b such that the lowering lift mechanism 400b aligns with the subframe support 126 located below the uppermost subframe support 126 at a second end 150 of the body frame 112b. Once the lowering lift mechanism 400b is aligned, the lowering lift mechanism 400b may push its cart onto the subframe support 126. As the lowering lift mechanism 400b pushes its cart 300 onto the subframe support 126, the female engagement mechanism 308 of the cart 300 may engage the male engagement mechanism 306 of the adjacent cart 300 located on the subframe support 126 of the body frame 112b, such that each of the carts 300 located on the subframe support are pushed towards the opposite lift frame 200a.

This process may be repeated until the plurality of carts 300 have traversed each of the subframe supports 126 of the body frames 112 in row 114a. Once a cart 300 has traversed the moving path of the row 114a, the cart will be located on the bottommost subframe support 126 at a position corresponding to the first end 148 of the body frame 112a.

In order for the cart 300 to transition from row 114a to row 114b, the lowering lift mechanism 400c may be configured such that it is capable of being raised into the lift frame 200a. In this embodiment, the lowering mechanism 400c may be raised into lift frame 200a in order to engage the cart 300 located at the first end 148 of the bottommost subframe support 126 of the body frame 112a. Once the lowering mechanism 400c has engaged the cart 300, it may be pulled into lift frame 200a, and lowered into lift frame 200c. The cart 300 may be lowered into lift frame 200c such that the cart 300 aligns with the uppermost subframe support 126 of body frame 112c at a first end 148. The cart 300 may then be pushed onto the uppermost subframe support 126 of the body frame 112c in order to begin traversing the moving path of row 114b.

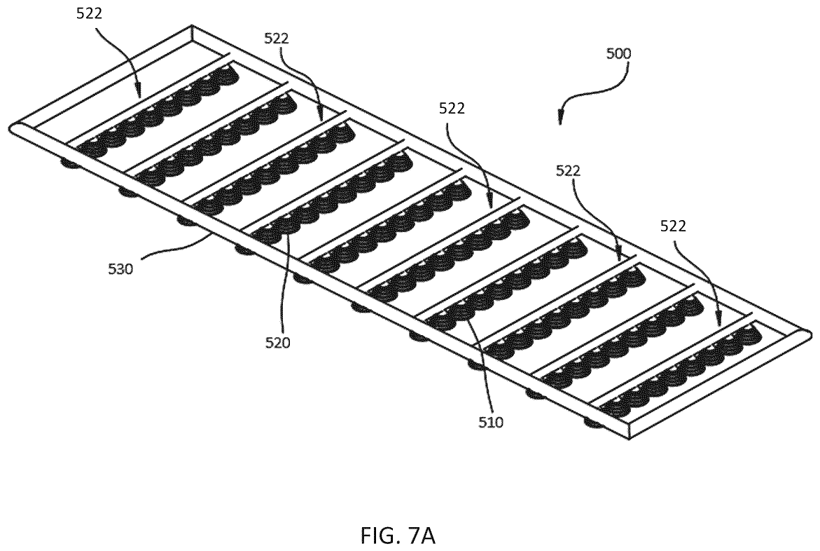

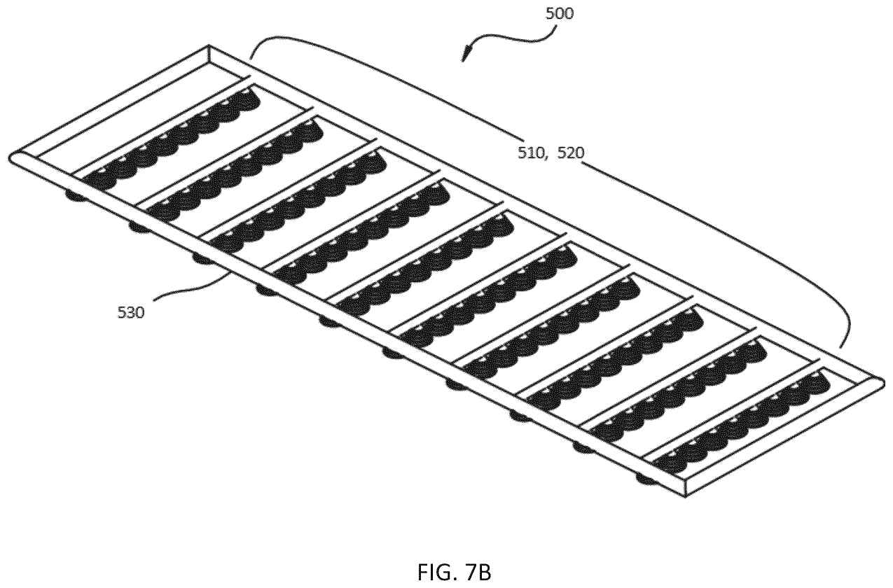

As the carts 300 traverse the modular grow tower assembly 100, a sustenance system 500 may provide nutrients and/or water to the crops carried by the carts 300. As illustrated in FIGS. 7A and 7B, in various embodiments, the sustenance system 500 may include a watering component 510 and/or a nutrient dosing component 520. The watering component 510 and nutrient dosing component 520 may be configured to distribute water and/or nutrients to one or more trays of crops at predetermined areas of the modular grow tower assembly 100. The watering component 510 and nutrient dosing component 520 may each comprise a plurality of spray nozzles 522, drip nozzles, flood nozzles, and/or other fluid dispensers mounted within and/or on the body frames 112 to provide water and/or nutrients to the crops located on the carts 300. The nozzles 522 may be mounted within each of the body frames 112 or only certain body frames 112 within each row 114 of the modular grow tower assembly 100. More particularly, the nozzles 522 may be mounted to the subframe supports 126. In these embodiments, the carts 300 may receive water and/or nutrients when passing through those body frames 112 in which one or more nozzles 522 are mounted.

In some embodiments, the watering component 510 may be coupled to one or more fluid lines 530, which distribute water and/or nutrients to one or more trays at predetermined areas of the modular grow tower 10. In some embodiments, the crops may be sprayed with a fluid to reduce buoyancy and/or flooding. Additionally, water usage and consumption may be monitored, such that at subsequent watering stations, this data may be utilized to determine an amount of water to apply to the crops (or remove from a cell) at that time.

The nutrient dosing component 520 may provide one or more of the crops and/or microgreens with a predetermined nutrient and/or dosage of nutrients. As discussed in more detail below, some embodiments may provide at least one watering component 510 that is distinct from the nutrient dosing component 520. In some embodiments, one or more of the nutrient dosing components 520 may be integral with one or more watering components 510 to provide a single station or mechanism for providing both water and nutrients (such as depicted in FIG. 7B).

The modular grow tower assembly 100 may also include a lighting system 550 (FIG. 1) including a plurality of lighting elements for emitting light toward the carts 300, as illustrated in FIG. 1. The lighting elements may include, for example, high intensity discharge (HID) lights, fluorescent lights, light-emitting diode (LED) lights, and/or the like. The lighting elements may be mounted within the body frames 112 and directed in a generally downward direction toward an upper surface of the carts 300. More particularly, the lighting elements may be mounted to the subframe supports 126. The lighting elements may be mounted within each of the body frames 112 or only certain body frames 112 within each row 114 of the modular grow tower system. Thus, the carts 300 receive direct light from the lighting elements when passing through those body frames 112 in which one or more lighting elements are mounted. In embodiments, the lighting elements are mounted to body frames 112 in the lowest row of the modular grow tower assembly 100.

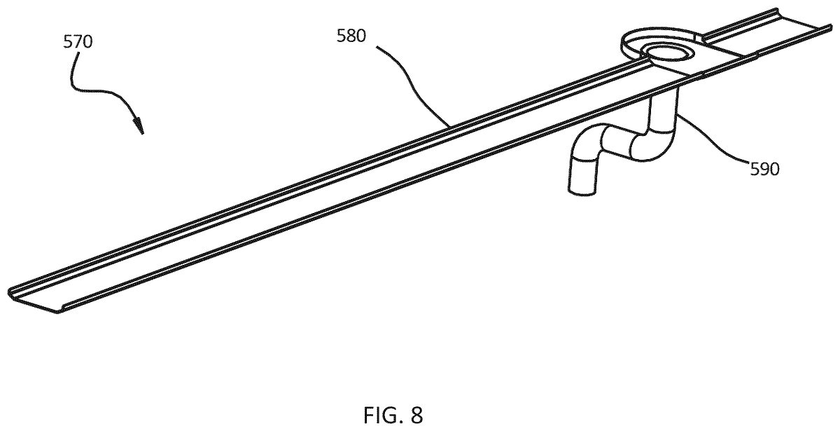

As further illustrated in FIG. 8, the modular grow tower 10 may include a drainage system 570. The drainage component 570 may include a draining trough 580 and a drainage pipe 590. In practice, the drainage trough 580 may collect excess water and/or nutrients that are dispersed by the watering component 510 and nutrient dosing component 520. The drainage trough 580 may transport the excess water and/or nutrients to the drainage pipe 590, which may be configured to carry the excess water and/or nutrients away from the modular grow tower 10.

As also illustrated in FIG. 1, the body frames 112a, 112b, 112c, 112d may have a plurality of drainage troughs 580 mounted to the subframe supports 126 of the body frames 112. In this embodiment, the drainage pipe 590 may be located outside the body frames 112, and may extend from a top end 106 to a bottom end 108 of the modular grow tower assembly 100 in a vertical direction. In this configuration, the draining pipe 590 may be configured to interact with each of the plurality of drainage troughs 580 located throughout the body frames 112. As excess water and/or nutrients are collected in the plurality of drainage troughs 580, gravity may act to carry the excess water and/or nutrients down through the drainage pipe 590, where it may be collected in a drainage bin. In some embodiments, the excess water and/or nutrients collected in the drainage bin may be recycled and reentered into the modular grow tower 10 via the watering component 510 and nutrient dosing component 520.

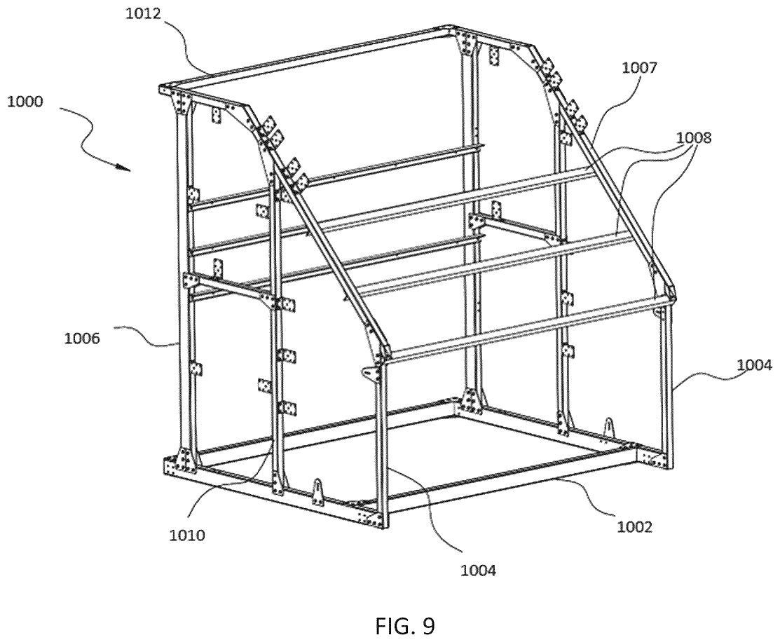

Turning now to FIG. 9, the modular grow tower 10 may include a harvest frame 1000. The harvest frame 1000 may be located on the side of the modular grow tower where the moving path terminates. For example, as illustrated in FIG. 1, the harvest frame 1000 is located proximal to the lift frame 200c, and the moving path which the carts 300 follow to traverse the modular grow tower assembly 100 terminates on a first end 148 of the body frame 112c on the bottommost subframe support 126.

In some embodiments, the harvest frame 1000 may include a rectangular base frame 1002. First supports 1004 and second supports 1006 may extend upwardly from the base frame 1002, and may be connected via diagonal supports 1007. Central supports 1010 may also extend upwardly from the base frame 1002 such that the central supports intersect the diagonal supports 1007. A plurality of cross members 1008 may be mounted in parallel between diagonal supports 1007. The harvest frame 1000 may further include a top support 1012, which may connect the second supports 1006. In some embodiments, the top support 1012 of the harvest frame 1000 may be aligned with the top end 218 of the adjacent lift frame 200. The harvest frame may have a height corresponding to a distance between the base frame 1002 and the top support 1012, a width corresponding to a distance between the first supports 1004, and a length corresponding to a distance between the first support 1004 and the second support 1006.

Referring to FIG. 9 in conjunction with FIG. 1, the raising lift mechanism 600 may be located between the second supports 1006 and the central supports 1010. The plurality of cross members 1008 may be used to support the harvesting component 700, and the sanitation component 800 may be located between the central supports 1010 and the first supports 1004.

In some embodiments, the raising lift mechanism 600 may be configured to pull carts 300 from the lift frame 200 located at the end of the moving path and into the harvest frame 1000. The raising lift mechanism 600 may be configured to move vertically up and down through the harvest frame 1000 between the rectangular base frame 1002 and the top support 1012. In some embodiments, the raising lift mechanism 600 may be further configured to move in a vertically upward direction beyond the top support 1012. For example, as illustrated in FIG. 1, the raising lift mechanism 600 may be configured to rise above the harvest frame 1000, such that the raising lift mechanism 600 may interact directly with the lift frame 200a.

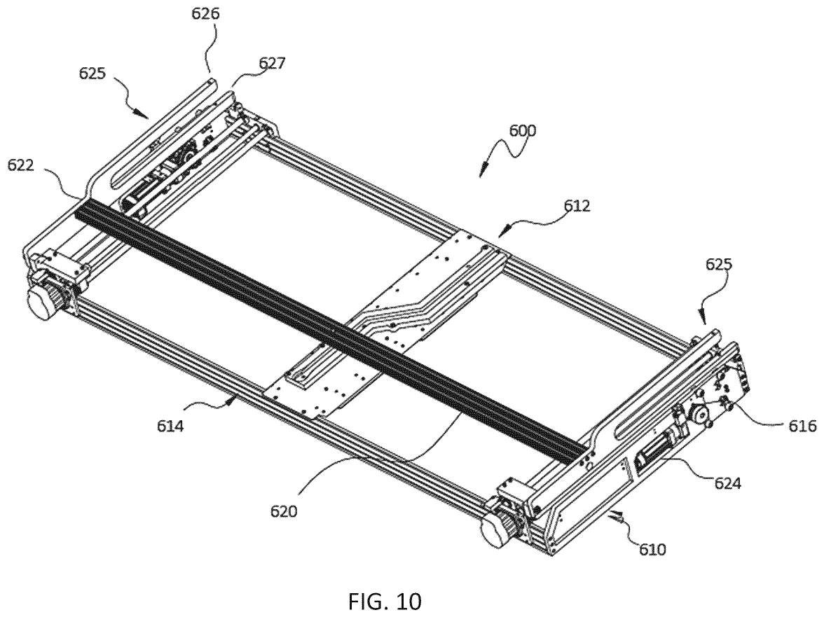

As illustrated in FIG. 10, the raising lift mechanism 600 may include a base frame 610 and a rail 620 having a first end 622 and a second end 624. The first end 622 and second end 624 of the rail 620 may each include fork members 625, which may include a first fork 626 and a second fork 627. The fork members 625 which may be configured to engage the wheels 310 of the carts 300. The fork members 625 may each include a roller 616, which may be configured to interact with the harvesting component 700. The rail 620 may be rotatably mounted to the base frame 610 such that the raising lift mechanism 600 may move between an initial position and a rotated position. When the fork members 625 are engaged with the wheels 310 of the cart 300, the rail 620 may be configured such that the cart 300 is overturned in the rotated position.

The rail 620 may be further configured to move in a longitudinal direction between an extended position 612 and a retracted position 614. In the retracted position 614, the fork members 625 of the rail 620 may be contained within the space provided between the second supports 1006 and the central supports 1010 of the harvest frame 1000. In the extended position 612, the forks may extend into the adjacent lift frame 200 to retrieve carts 300 from the end of the serpentine moving path. In various embodiments, the fork members 625 of the raising lift mechanism 600 may extend from the harvest frame 1000 and into lift frame 200c in order to engage carts 300 which have reached the end of the serpentine moving path.

As the rail 620 extends, the first fork 626 and the second fork 627 of the fork mechanisms 625 may engage the wheels 310 of the cart 300, such that when the rail 620 has achieved the extended position 612, the wheels 310 of the cart 300 may be completely secured between the first fork 626 and second fork 627 of the forking mechanisms 625. Once the wheels 310 are secured within the first fork 626 and second fork 627, the raising lift mechanism 600 may lift the cart 300 in a vertical direction to disengage the cart 300 from its adjacent cart, and to ensure that the cart 300 has clearance from the support stops 128 located on the ends of each subframe support 126. After the cart 300 is disengaged, the rail may return to the retracted position 614, such that the cart 300 is pulled into the harvest frame 1000.

Once the cart 300 is pulled into the harvest frame 1000, the raising lift mechanism 600 may raise the cart 300 in a vertical direction to the top support 1012 of the harvest frame 1000. When the raising lift mechanism 600 is aligned with the top support 1012, the raising lift mechanism 600 may interact with the harvesting component 700 such that the crops in the cart 300 are harvested.

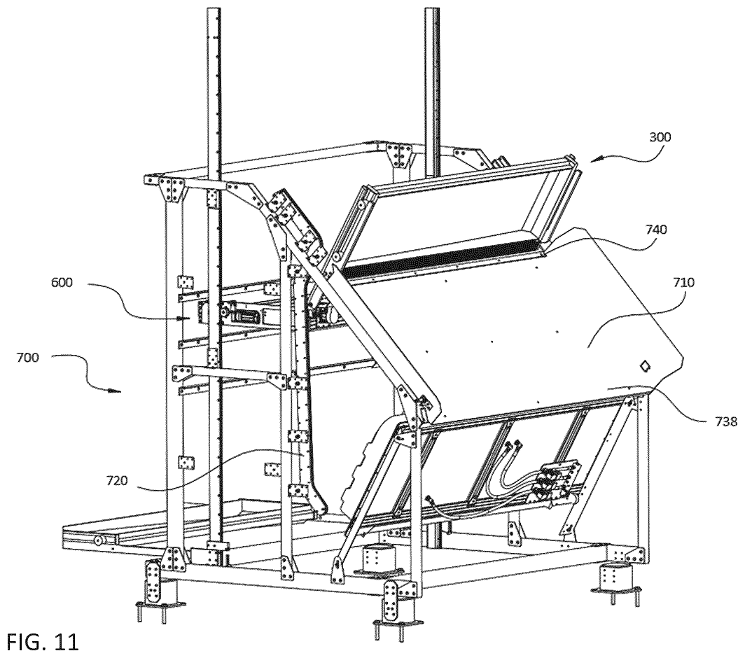

The harvesting component 700 is most clearly illustrated in FIG. 11. As can be seen, the harvesting component 700 may comprise a tray 710 that is rotatably mounted within the harvesting component 700. Specifically, the tray 710 is positionable between a receiving position and a harvesting position. As shown in FIG. 11, the tray 710 of the harvesting component 700 is in the harvesting position such that a forward end 738 of the tray 710 is tilted lower than an opposite rearward end 740 of the tray 710. Additionally, the harvesting component may include guides 720, which may be used to engage the raising lift mechanism 600.

Once the raising lift mechanism 600 has been raised to the top support 1012 of the harvest frame 1000, the rail 620 may be rotated to the rotated position such that the rollers 616 of the fork mechanisms 625 are received by the guides 720 of the harvesting component 700. In some embodiments, the rail 620 of the raising lift mechanism 600 may be configured to rotate a full 180 degrees, however, the rail 620 may only need to rotate to the extent necessary to engage the roller 616 with the guides 720.

When the guides 720 have received the rollers 616 of the raising lift mechanism 600, the raising lift mechanism 600 may begin to move downward in a vertical direction towards the base frame 1002 of the harvest frame 1000. As the raising lift mechanism 600 moves in the downward direction, the guides 720 of the harvesting component 700 ensure that the cart 300 is at the appropriate angle for harvesting the crops whenever the cart 300 reaches the harvesting tray 710.

It should be noted that, as the carts 300 traverse the modular grow tower assembly 100, the modular grow tower 10 may detect a current growth, a current development, and/or a current output of crops and may determine when harvesting is warranted. If harvesting is warranted prior to the cart 300 reaching the harvesting component 700, modifications to a growing recipe may be made for that particular cart 300 until the cart 300 reaches the harvesting component 700. Conversely, if a cart 300 reaches the harvesting component 700 and it has been determined that the crops in that cart 300 are not ready for harvesting, the modular grow tower 10 may commission that cart 300 for another lap through the modular grow tower assembly 100. This additional lap may include a different dosing of light, water, nutrients, etc. and the speed of the cart 300 could change, based on the development of the crops on the cart 300. If it is determined that the crops on a cart 300 are ready for harvesting, the harvester component 700 may facilitate that process.

Once the cart 300 has emptied its crops onto the harvest tray 710, the raising lift mechanism 600 may continue to move in a downward direction toward the base frame 1002 of the harvest frame 1000. In this embodiment, the guides 720 may continue to support the rollers 616 of the raising lift mechanism 600 as the raising lift mechanism 600 moves in a downward direction below the harvesting component 700, such that the cart 300 remains at an appropriate angle for interfacing with the sanitation component 800. The sanitation component 800 may be implemented to remove any particulate, plant material, organic material etc. that may remain on the cart 300 after harvesting. As such, the sanitation component 800 may implement any of a plurality of different washing mechanisms, such as high pressure water, high temperature water, and/or other solutions for cleaning the cart 300.

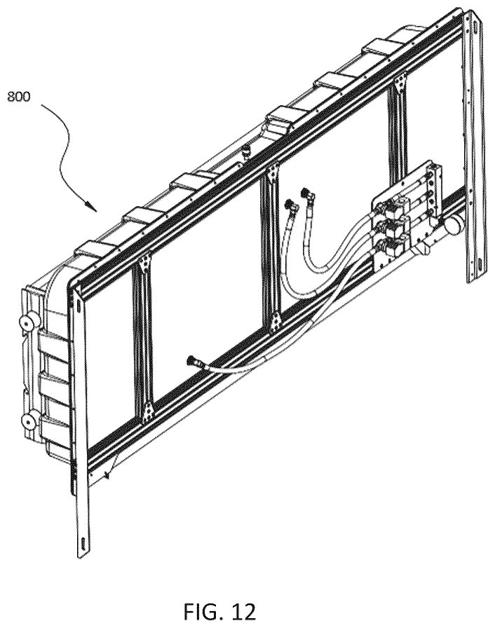

The sanitation component is most clearly illustrated in FIG. 12. In various embodiments, the sanitation component 800 may receive a cart 300 that has been overturned by the guides 720 of the harvesting component. In other embodiments, the sanitation component 800 may be configured to overturn the cart 300 itself. As described above, some embodiments may be configured such that the raising lift mechanism 600 overturns carts 300 and, as such, the carts 300 may remain in that position when entering the sanitation component 800. Regardless, the sanitation component 800 may clean and/or otherwise sanitize the cart 300 such that the cart 300 is prepared for receiving new crops, seeds, plant material, and/or organic material. In some embodiments, the sanitation component 800 may include one or more sensors (e.g., ultraviolet sensors, imaging sensors, microbial sensors, etc.) for determining the cleanliness of the cart 300. If the sanitation component 800 does not clean the cart 300 to a predetermined threshold, the master controller 20 may determine whether the cart is able to be cleaned to meet the threshold. If so, the cart 300 and may be rerun through the sanitation component. In some embodiments, the cart 300 may simply remain in the sanitation component 800 while this determination and re-cleaning occur. If the sanitation component 800 cannot clean the cart 300, the master controller 20 may decommission the cart 300 and introduce a new cart 300.

After the cart 300 has been effectively cleaned, the raising lift mechanism 600 may continue to move in a downward direction towards the base frame 1002 of the harvest frame 1000 until the rollers 616 of the raising lift mechanism 600 are no longer restricted by the guides 720. At this point, the rail 620 may be rotated to the initial position. In this position, the raising lift mechanism 600 may be located adjacent to the base frame 1002 of the harvest frame 1000, and the fork mechanisms 625 of the raising lift mechanism 600 may remain engaged with the cart 300 which has been sanitized.

At this point, the sanitized cart 300 may be prepared to receive new crop matter and reenter the modular grow tower assembly 100. In some embodiments, the raising lift mechanism 600 may raise the sanitized cart 300 such that it is elevated above the harvest frame 1000. In this embodiment, the raising lift mechanism 600 may traverse the outside of the lift frame 200 located in the row 114 above the harvest frame 1000. As illustrated in FIG. 1, the raising lift mechanism 600 may be lifted above the harvest frame 1000 such that the raising lift mechanism 600 is aligned with lift frame 200a, which is located in row 114a. In some embodiments, the raising lift mechanism 600 may be configured to be lifted until it reaches the seeding component 900. In embodiments which include multiple rows 114, such as the embodiment illustrated in FIG. 1, the seeding component 900 may be mounted to the lift frame 200a located on the highest row 114a of the modular grow tower assembly 100 on the same side of the modular grow tower assembly where the harvest frame 1000 is located. The seeding component 900 may be mounted to the lift frame 200a such that the seeding component does not extend above a top end 106 of the modular grow tower assembly 100.

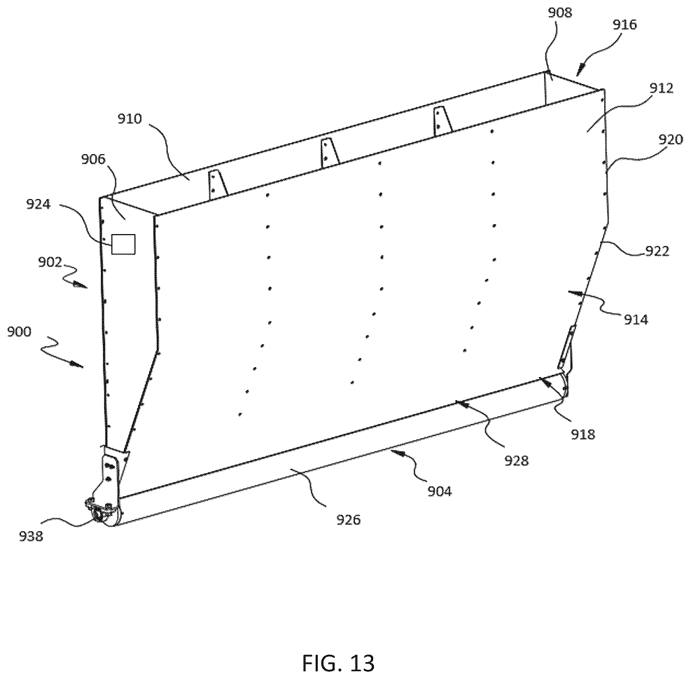

The seeding component 900 may be configured to provide crop material to one or more carts 300 as the carts 300 pass the seeding component 900 in the modular grow tower 10, as illustrated in FIG. 13. Depending on the particular embodiment, each cart 300 may include a single section tray 320 for receiving crop material. In some embodiments, the carts 300 may comprise multiple section trays for receiving individual crop materials in each section. The crop material may be laid out according to a desired depth of crop material, a desired quantity of crop material, a desired surface area of crop material, and/or according to other criteria. In some embodiments, the crop material may be pre-treated with nutrients and/or anti-buoyancy agents, such as water, as these embodiments may not utilize soil to grow the crops.

Referring still to FIG. 13, the seeding component 900 may generally include a dispenser 902 and a drum 904 rotatably mounted to the dispenser 902. The dispenser 902 includes a first end wall 906, a second end wall 908 opposite the first end wall 906, a first side wall 910, and a second side wall 912 opposite the first side wall 910. The first side wall 910 and the second side wall 912 extend between the first end wall 906 and the second end wall 908 and define an open interior 914. The dispenser 902 has an open top end 916, through which crop material enters the open interior 914, and an open bottom end 918, through which crop material is dispensed out of the open interior 914. The dispenser 902 has a length defined by a distance between the first end wall 906 and the second end wall 908, a width defined by a distance between the first side wall 910 and the second side wall 912, and a height defined by a distance between the open bottom end 918 and the open top end 916.

As discussed herein, the width of the dispenser 902 along the height of the dispenser 902 may not be constant. In embodiments, the second side wall 912 of the dispenser 902 has a vertical wall portion 920 and an angled wall portion 922 relative to the vertical wall portion 920. The vertical wall portion 920 may extend parallel to the first side wall 910 and the angled wall portion 922 may extend toward the first side wall 910 such that the open bottom end 918 has a width extending between the first side wall 910 and the second side wall 912 that is less than a width of the open top end 916. Accordingly, crop material entering the dispenser 902 contacts the angled wall portion 922 to accumulate at the open bottom end 918. The dispenser 902 may include a sensor 924 for detecting an amount of crop material within the dispenser 902. In embodiments, the sensor 924 is located proximate to the open top end 916 of the dispenser 902 to detect when the level of crop material reaches a predetermined height within the open interior 914.

The drum 904 has an outer surface 926 that contacts seed falling through the open bottom end 918 of the dispenser 902. In embodiments, the outer surface 926 of the drum 904 is cylindrical. The drum 904 may also have a length extending along the entire open bottom end 918 of the dispenser 902 such that the length of the drum 904 is equal to a length of the dispenser 902 extending between the first end wall 906 and the second end wall 908. It should be appreciated that the drum 904 is a cylindrical member rotatably mounted at the open lower end of the dispenser 902 in a spaced apart manner so as to provide a gap 928 between the open lower end and the drum 904, defined by a distance between the drum 904 and the angled wall portion 922 of the dispenser 902. A motor 938 is provided at an end of the drum 904.

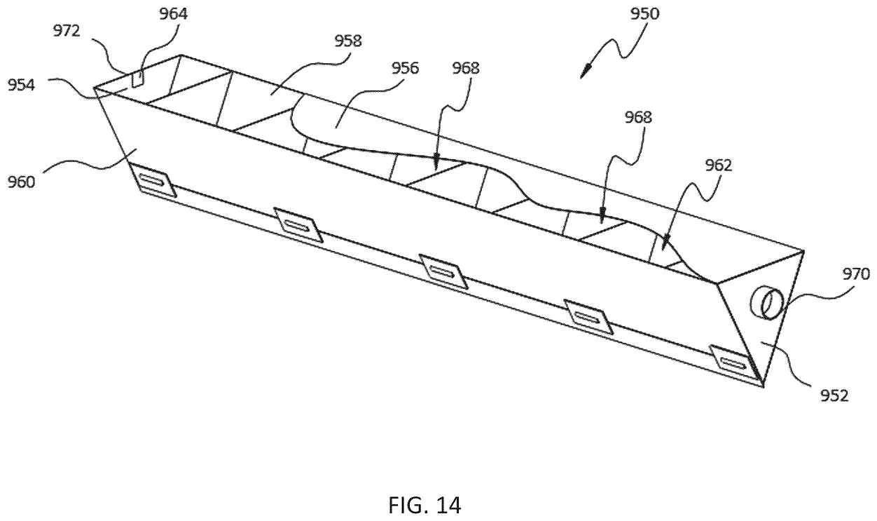

The seeding component 900 may further comprise a transfer apparatus 950, as illustrated in FIG. 14. As discussed herein, the transfer apparatus 950 is utilized for transferring crop material to the seeding component 900. The transfer apparatus 950 includes a first end wall 952 and a second end wall 954 opposite the first end wall 952, a top wall 956, a first side wall 958, and a second side wall 960 opposite the first side wall 958. The top wall 956, the first side wall 958, and the second side wall 960 extend between the first end wall 952 and the second end wall 954 and define an open interior 962. The transfer apparatus 950 has a length defined by a distance between the first end wall 952 and the second end wall 954, a width defined by a distance between the first side wall 958 and the second side wall 960, and a height defined by a distance between the top wall 956 and lower point, such as a point of contact between the first side wall 958 and the second side wall 960.

As discussed herein, the width of the transfer apparatus 950 may not be constant along the height of the transfer apparatus 950. The transfer apparatus 950 may have any suitable geometry for housing crops and/or crop material. In embodiments, as shown, the transfer apparatus 950 has a triangular cross-section geometry such that the width of the transfer apparatus 950 at the top wall 956 is greater than the width of the transfer apparatus 950 opposite the top wall 956. However, the transfer apparatus 950 may have other geometries such as a cylindrical cross-section, a rectangular cross-section, and the like.

The transfer apparatus 950 may be positioned within the seeding component 900 described herein. Specifically, the transfer apparatus 950 extends through the open top end 916 of the dispenser 902 of the seeding component 900 to be positioned within the open interior 914 of the dispenser 902. In this embodiment, a receiving hole may be formed in each end wall of the dispenser 902 to receive a corresponding one of the inlet port 970 and the vacuum port 972 of the transfer apparatus 950. Thus, once the transfer apparatus 950 receives a required amount of crops and/or crop material, as detected by the one or more sensors 964 within the transfer apparatus 950, the vacuum source in communication with the transfer apparatus 950 may be deactivated such that a pivoting wall portion 966 is permitted to rotate to the open position.

Once the pivoting wall portion 966 moves to the open position, the crops and/or crop material are released into the open interior 914 of the dispenser 902. The transfer apparatus 950 may further include a plurality of baffles 968 arranged in a spaced apart manner within the open interior 962 thereof. It should be appreciated that each baffle 968 has a geometry corresponding to a geometry defined by the first side wall 958, the second side wall 960, and the top wall 956 of the transfer apparatus 950. Thus, in the present embodiment, each baffle 968 has a triangular geometry. As shown, the transfer apparatus 950 includes seven baffles 968 defining cight individual compartments for receiving seed.

As previously described, the raising lift mechanism 600 may be raised from the base frame 1002 of the harvest frame 1000 until the sanitized cart 300 secured by the raising lift mechanism 600 is aligned with the dispenser 902 of the seeding component 900. Once the raising lift mechanism 600 is properly positioned, the rail 620 may extend to the extended position 612. As the rail 620 extends, the cart 300 may pass under the dispenser 902 of the seeding component 900, which may provide new crops and/or crop material to the cart 300.

As the rail 620 continues to extend, the cart 300 will pass into the lift frame 200 on which the seeding component 900 is mounted. For example, in the embodiment illustrated in FIG. 1, the cart 300 may receive crops and/or crop material from the seeding component 900 as the rail 620 extends to the extended position 612, such that the cart 300 is extended into lift frame 200a once the rail 620 achieves the extended position 612.

Once the rail 620 of the lifting mechanism 600 is in the extended position 612, the cart 300 may be fully contained within the lift frame 200 upon which the seeding component 900 is mounted. At this point, the seeded cart 300 may be transferred from the raising lift mechanism 600 to the lowering lift mechanism 400 located within the lift frame 200, such that the lowering lift mechanism 400 may reinsert the seeded cart 300 into the modular grow tower assembly 100.

The transfer of the seeded cart 300 from the raising lift mechanism 600 to the lowering lift mechanism 400 will be described in detail herein. Initially, the lowering lift mechanism 400 may comprise a post 460 (FIG. 6) which is configured to be inserted into a post receptacle 360 located on the bottom of the cart 300. As the raising lift mechanism 600 passes below the seeding component 900 and into the lift frame 200, the raising lift mechanism 600 lowers the cart 300 such that the post 460 of the lowering lift mechanism 400 is received by the post receptacle 360 of the cart 300 prior to the rail 620 achieving the extended position 612.

Once the post 460 is secured within the post receptacle 360, the rail 620 of the raising lift mechanism 600 may return to the retracted position 614. As the rail 620 retracts to the retracted position 614, the post 460 of the lowering lift mechanism 400 may secure the cart 300 such that the cart is not able to move in a longitudinal direction. Thus, as the rail 620 retracts to the retracted position 614, two of the wheels 310c, 310d of the cart 300 are released from the fork mechanism 625 of the raising lift mechanism 600.

After the two wheels 310c, 310d of the cart 300 are released from the fork mechanisms 625 of the raising lift mechanism 600, the raising lift mechanism 600 may lift the cart 300 such the post 460 of the lowering lift mechanism 400 is removed from the post receptacle 360 of the cart 300. With the post 460 disengaged, the rail 620 of the raising lift mechanism 600 may extend to the extended position 612.

In the extended position 612, the cart 300 may be situated such that it is aligned with the receiving plate 410 of the lowering lift mechanism 400. With the cart 300 properly aligned with the receiving plate 410, the raising lift mechanism 600 may lower the cart 300 onto the receiving plate 410 of the lowering lift mechanism 400. Once the cart 300 has been lowered onto the receiving plate 410 of the lowering lift mechanism 400, the rail 620 of the raising lift mechanism 600 may return to the retracted position 614. As the rail 620 retracts, the remaining wheels 310a, 310b, are released from the forking mechanisms 625, such that the cart 300 is fully released from the raising lift mechanism 600.

With the seeded cart 300 secured on the lowering lift mechanism 400, the lowering lift mechanism 400 may be configured to raise the cart 300 to the top of the lift frame 200. Once the lowering lift mechanism has reached the top of the lift frame 200, the cart 300 may be pushed onto the uppermost subframe support 126 of the body frame 112 adjacent to the lift frame 200, such that the seeded cart 300, in various embodiments, may begin to traverse a serpentine moving path of the modular grow tower assembly 100. After transferring the seeded cart 300 to the lowering lift mechanism 400, the raising lift mechanism 600 may be lowered through the harvest frame 1000 in order to obtain a new cart 300 located at the end of the serpentine moving path.

However, as discussed previously, the motion of carts does not need to follow a serpentine path nor is it limited to one set sequence. One possible method of moving carts in a modular grow tower assembly may be alternating which row carts are moved to, in a non-sequential or non-serpentine path. This alternating method only moves carts when necessary, to designated new rows of the modular grow tower assembly, based on specific growing requirements such as crop height, row spacing, lighting elements, nutrient application systems, visual inspections, harvesting, and/or washing. This method optimizes the movement of carts by reducing the overall motion required and consequently minimizing wear on the carts and the need for an extensive motion system.

In various embodiments, the alternating rows method is controlled by a computer program executed by the master controller that dictates the sequence of cart movements based on specific growing requirements. For instance, the system can start by moving a cart from the top row to row A, and in the next cycle, move another cart from the top row to row B. This sequence can be customized to suit various growing conditions, ensuring that carts are moved efficiently and only when necessary.

Such a method allows for grouping certain rows together and alternating the movement of these groups. For example, the system can alternate between moving carts in rows A, C, and E in one cycle and rows B, D, and F in the next cycle. Another possibility is moving carts from row A to C in one cycle, then only move carts from rows B to D in the next. Another possibility is moving carts from rows A, B, and C to the next level of rows D, E, and F or even to the bottom rows, for the sake of example could be labeled X, Y, and Z. This reduces the overall motion required during an entire grow cycle of a crop from start to finish, thereby lowering the wear on the carts and minimizing the demand on the lift mechanisms.

Another option, in various embodiments, is allowing different rows of carts to be consolidated together into one entirely new row, and another possibility is individual carts can alternately be sent to a different row during a movement cycle. This is particularly useful when rows are spaced at different heights, and therefore accommodate continually growing crops. Another possible benefit is minimizing the cost of lighting systems by only requiring lighting on one or two rows. There are many other reasons to justify providing flexibility of cart paths and allowing consolidating rows. Accordingly, alternating and shuffling carts and rows can be performed in a large variety of ways in accordance with the present disclosure.

In various embodiments, the non-sequential movement of the carts is controlled by a computer program executed by the master controller, which dictates the cart movement sequence based on the specific growing requirements. This sequence can be customized in other variations to suit various growing conditions, grow times of different crops, reducing the frequency of cart movements and enhancing system efficiency. Correspondingly, a cart tracking system of sensors can allow the master controller to keep track of the location of each cart and monitor the growing properties of the crops inside each cart. In various embodiments, the master controller can also be configured to allow users to test and predict different patterns of cart movements to discover optimal cart pathways and patterns.

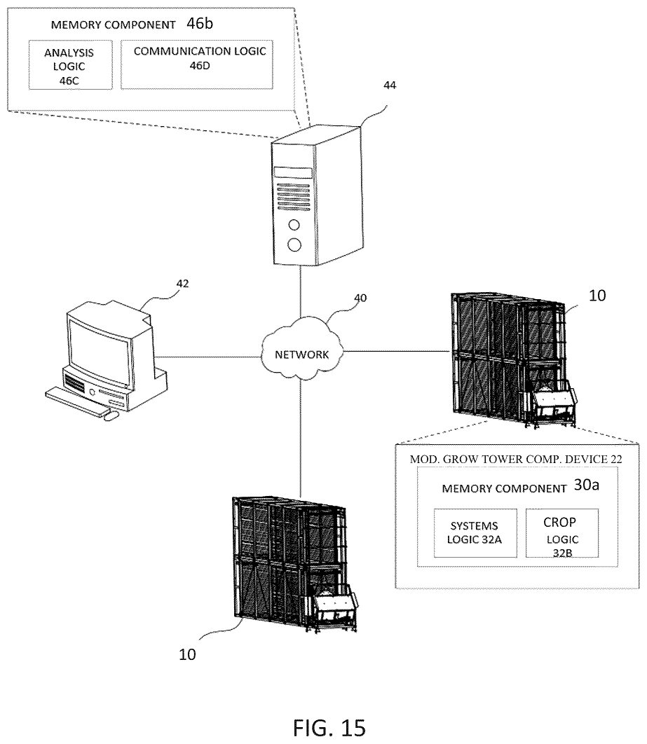

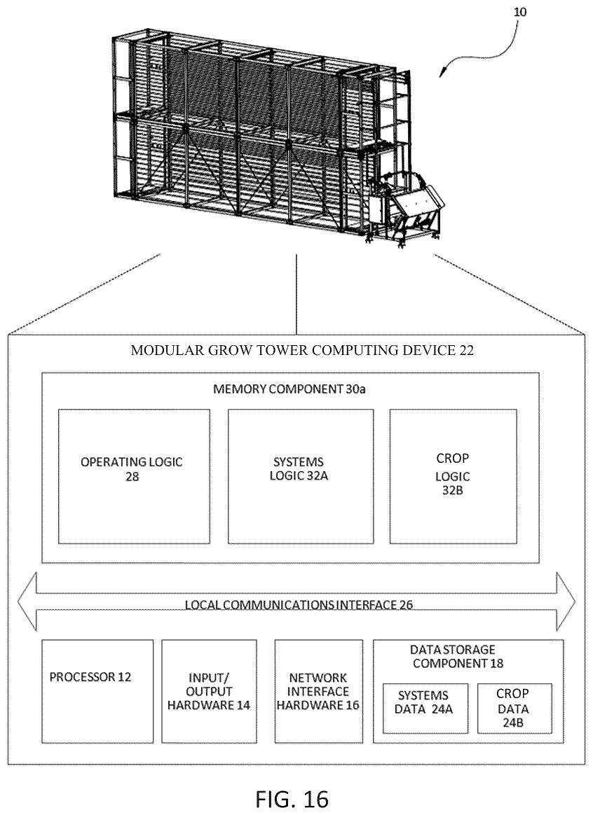

Turning now to FIGS. 15 and 16, a computing environment for providing a modular grow tower 10, may also be provided. As described above, the modular grow tower 10 may include the master controller 20, which may be provided by a modular grow tower computing device 22. The modular grow tower computing device 22 may include a memory component 30a, which stores systems logic 32A and crop logic 32B. The systems logic 32A may monitor and control operations of one or more of the components of the modular grow tower 10; may provide one or more user interfaces; and/or may otherwise cause the modular grow tower 10 to perform the functionality provided herein. As an example, the systems logic 32A may cause actuation of one or more hardware components of the modular grow tower 10; receive and/or determine updates, upgrades, or adjustments to current grow recipes; receive new grow recipes, and/or otherwise control operations of the modular grow tower 10. The crop logic 32B may be configured to determine crop growth and may facilitate implementation of the grow recipe via the systems logic 32A.

In various embodiments, the master controller or other component of the computing environment can monitor and measure sensor data, growth parameters, or other environmental factors, such as, but not limited to, temperature, humidity, light intensity, light duration, light spectrum, water quality/purity, water quantity, watering frequency, water temperature, water polarization, water flow rate, water filtration system efficiency, water mineral content, nutrient concentration, nutrient composition, pH level, airflow, CO₂ concentration, soil type, soil moisture, soil pH, soil composition, tray size and shape, tray material, growth medium, plant density, genetic factors, pollination, growth stage, harvest timing, microbial activity, oxygen levels, feeding frequency (for insects and larvae), substrate type (for fungus), light-dark cycles, movement frequency, sound vibrations, structural support (stakes, netting, cages, trellis, etc.), climatic conditions, altitude/barometric pressure, cleaning/washing/sanitizing/hygiene practices, growth hormones, symbiotic relationships if different crops are mixed, different crop or seed varieties in one tray, amount of human contact, pre-planting treatments or coatings applied to seeds, crop harvest weight, crop color, crop uniformity, crop density, crop level, nutrient content of crop harvests, and/or elemental analysis of crop harvests.

Additional factors that can be measured and/or used to customize tower operations include cart paths, cart maintenance reports, total electricity use, total water use, total seed or crop-starting material amount or weight, total time of carts in motion, total downtime of no motion, maintenance history, usage history, change history, video monitoring of individual systems, video monitoring of facility, user logs, software update history, bug reports, weather, and/or user notes.

Additionally, the modular grow tower 10 may be coupled to a network 40. The network 40 may include the internet or other wide area network, a local network, such as a local area network, a near field network, and/or a peer-to-peer network, such as via Bluetooth or a near field communication (NFC) network. The network 40 is also coupled to a user computing device 42, a remote computing device 44, and/or another modular grow tower 10 having a tower computing device, similar to the modular grow tower computing device 22. The user computing device 42 may be configured as a personal computer, laptop, mobile device, tablet, server, etc. and may be utilized as an interface through which a user may interact with one or more devices depicted in FIG. 1. In some embodiments, the remote computing device 44 may send a grow recipe to the modular grow tower computing device 22 for implementation by the modular grow tower 10. The modular grow tower 10 may then send notification to a user of the user computing device 42.

The remote computing device 44 may be configured as a server, personal computer, tablet, mobile device, etc. and may be utilized for machine to machine communications. Accordingly, the remote computing device 44 may include a memory component 46b. The memory component 46b may store analysis logic 46C and communication logic 46D. The analysis logic 46C may be configured to receive a grow recipe, determine updates, upgrades, and/or adjustments to a grow recipe and determine differences between the grow recipe received and the current grow recipe that is stored by the remote computing device 44. The remote computing device 44 may alter a stored grow recipe and/or save the received grow recipe for communicating the update, upgrade or adjustment to another modular grow tower 10 via the communication logic 46D.

FIG. 16 depicts a tower computing device 22, according to embodiments described herein. As discussed above, the modular grow tower computing device 22 includes a memory component 30a, a processor 12, input/output hardware 14, network interface hardware 16, and a data storage component 18 (which stores systems data 24A, crop data 24B, and/or other data). Each of the components of the modular grow tower computing device 22 may be communicatively coupled to a local communications interface 26. The local communications interface 26 is generally not limited by the present disclosure and may be implemented as a bus or other communications interface to facilitate communication among the components of the master controller coupled thereto.

The memory component 30a may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), Blu-Ray discs, and/or other types of non-transitory computer-readable mediums. Depending on the particular embodiment, these non-transitory computer-readable mediums may reside within or outside the modular grow tower computing device 22. The memory component 30a may store, for example, operating logic 28, the systems logic 32A, and the crop logic 32B. The operating logic 28, the systems logic 32A and the crop logic 32B may each include a plurality of different pieces of logic, each of which may be embodied as a computer program, firmware, and/or hardware, as an example.

The operating logic 28 may include an operating system and/or other software for managing components of the modular grow tower computing device 22. As discussed above, the systems logic 32A and the crop logic 32B may reside in the memory component 30a and may be configured to perform the functionality, as described above. In some embodiments, the systems logic 32A and the crop logic 32B may reside on different computing devices. As an example, one or more of the functionalities and/or components described herein may be provided by the user computing device 42 and/or remote computing device 44. While the modular grow tower computing device 22 is illustrated with the systems logic 32A and the crop logic 32B as separate logical components, this is only an example. In some embodiments, a single piece of logic (and/or several linked modules) may cause the modular grow tower computing device 22 to provide the described functionality.

The processor 12 may include any processing component operable to receive and execute instructions (such as from the data storage component 18 and/or the memory component 30a). Illustrative examples of the processor 12 include, but are not limited to, a computer processing unit (CPU), a many integrated core (MIC) processing device, an accelerated processing unit (APU), a digital signal processor (DSP). In some embodiments, the processor 12 may be a plurality of components that function together to provide processing capabilities, such as integrated circuits (including field programmable gate arrays (FPGA)) and the like.

The input/output hardware 14 may include and/or be configured to interface with microphones, speakers, a display, and/or other hardware. That is, the input/output hardware 14 may interface with hardware that provides a user interface or the like. For example, a user interface may be provided to a user for the purposes of adjusting settings, viewing a status, and/or the like.

The network interface hardware 16 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the modular grow tower computing device 22 and other computing devices, such as the user computing device 42, the remote computing device 44, and/or other devices.

The data storage component 18 may generally be any medium that stores digital data, such as, for example, a hard disk drive, a solid state drive (SSD), a compact disc (CD), a digital versatile disc (DVD), a Blu-Ray disc, and/or the like. It should be understood that the data storage component 18 may reside local to and/or remote from the modular grow tower computing device 22 and may be configured to store one or more pieces of data and selectively provide access to the one or more pieces of data.

It should be understood that while the components in FIG. 16 are illustrated as residing within the modular grow tower computing device 22, this is merely an example. In some embodiments, one or more of the components may reside external to the modular grow tower computing device 22. It should also be understood that, while the modular grow tower computing device 22 is illustrated as a single device, this is also merely an example. That is, the modular grow tower computing device 22 may represent a plurality of devices that are communicatively coupled to one another and provide the functionality described herein.

Additionally, while the modular grow tower computing device 22 is illustrated with the various logic components (e.g., the operating logic 28, the systems logic 32A, and the crop logic 32B) and data components (e.g., the systems data 24A and the crop data 24B) as separate components, this is also an example. In some embodiments, a single piece of logic (and/or a plurality of linked modules) and/or a single data component (and/or a plurality of linked modules) may also cause the modular grow tower computing device 22 to provide the functionality described herein.

Similarly, while the modular grow tower computing device 22 is depicted in a “PC” environment, it should be understood that at least some embodiments may not be limited in this way. Specifically, some embodiments may be configured such that the modular grow tower computing device 22 is configured as and/or includes a programmable logic controller (PLC) and/or other computing infrastructure. To the extent that the modular grow tower 10 utilizes a PLC, appropriate equivalents of the components described with reference to FIGS. 15 and 16 may be utilized.

As illustrated above, various embodiments for providing a modular grow tower 10 are disclosed. These embodiments may be configured to produce an excess amount of crops per day (e.g., in excess of 20,000 pounds, 200,000 pounds, etc. of crop material per day (depending on the type of crop being grown)). Additionally, embodiments provided here may utilize significantly less water and electricity than conventional solutions.

While particular embodiments and aspects of the present disclosure have been illustrated and described herein, various other changes and modifications can be made without departing from the scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, and methods for providing a modular grow tower system. It should also be understood that these embodiments are merely exemplary and are not intended to limit the scope of this disclosure.

We claim:

1. A modular grow tower system comprising:
a modular grow tower assembly having:
a plurality of body frames;
a plurality of lift frames; and
a plurality of rows extending in a longitudinal direction and stacked in a vertical direction;
a plurality of carts for supporting crop material, each cart including:
a plurality of wheels; and
a tray for holding crop material;
one or more lowering lift mechanisms for vertically translating the carts between rows;
one or more raising lift mechanisms for vertically translating the carts;
a sustenance system for providing water and nutrients to the crop material;
a lighting system including lighting elements mounted within the body frames;
a drainage system comprising drainage troughs and drainage pipes for collecting and transporting excess water and nutrients; and
a master controller for managing and controlling operations of the modular grow tower system.

2. The modular grow tower system of claim 1, wherein an individual one of the one or more raising lift mechanisms is located within a harvest frame.

3. The modular grow tower system of claim 1, wherein the one or more lowering lift mechanisms are positioned within the lift frames.

4. The modular grow tower system of claim 1, wherein the modular grow tower assembly is configurable to adjust a size and arrangement of the modular grow tower assembly by adding or removing body frames or lift frames.

5. The modular grow tower system of claim 1, wherein the carts traverse a moving path through the modular grow tower assembly, facilitated by the lowering lift mechanisms and the raising lift mechanisms.

6. The modular grow tower system of claim 5, wherein the moving path comprises a serpentine moving path.

7. The modular grow tower system of claim 1, further comprising:
a seeding component mounted on one of the lift frames for dispensing crop material into the carts;
a harvesting component for harvesting crop material from the carts; and
a sanitation component for cleaning the carts after harvesting.

8. The modular grow tower system of claim 7, wherein the sanitation component includes one or more ultraviolet sensors, imaging sensors, or microbial sensors.

9. The modular grow tower system of claim 1, wherein the master controller is configured to manage environmental factors including: lighting, temperature, humidity, airflow, and nutrient delivery through the sustenance system.

10. The modular grow tower system of claim 9, wherein the master controller is configured to adjust the environmental factors and grow recipes based on user input.

11. The modular grow tower system of claim 1, wherein the lowering lift mechanisms and the raising lift mechanisms are synchronized to facilitate a transition of carts between different rows and sections of the modular grow tower assembly.

12. The modular grow tower system of claim 1, wherein the carts include sensors for monitoring crop growth and development, wherein the master controller adjusts one or more grow recipes based on data from the sensors.

13. The modular grow tower system of claim 1, wherein the sustenance system is configured to deliver precise amounts of water and nutrients to the crop material and includes spray nozzles, drip nozzles, flood nozzles, and fluid lines.

14. The modular grow tower system of claim 1, wherein the drainage system is configured to reuse collected water and nutrients within the sustenance system.

15. The modular grow tower system of claim 1, wherein each cart includes male and female engagement mechanisms for connecting adjacent carts to maintain alignment and ensure smooth movement through the modular grow tower assembly.
